(19) United States
(12) Patent Application Publication
(10) Pub. No.: US 2014/0363998 A1
(43) Pub. Date: Dec. 11, 2014

(54) MOUNTING ASSEMBLY FOR CONNECTOR

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: ZHAN-YANG LI, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/294,331

(22) Filed: Jun. 3, 2014

(30) Foreign Application Priority Data
Jun. 7, 2013 (CN) 2013102252708

(51) Int. Cl. H01R 12/70

(52) U.S. Cl. CPC H01R 12/7005
USPC 439/345

(57) ABSTRACT

A mounting assembly is configured for plugging a plug connector into a socket connector of a circuit board. The mounting assembly comprises a mounting seat and an operating member. The mounting seat is configured for mounting the circuit board and includes a sliding slot and a gap located at an end of the sliding slot. The operating member includes a pair of clamping arms for clamping the plug connector. Each clamping arm includes a sliding tab capable of sliding along the sliding slot. When the sliding tab is slid towards the gap along a first direction, the plug connector is capable of being plugged into the socket connector. In addition, the sliding tab is capable of moving away from the gap along a second direction that is substantially perpendicular to the first direction for detaching the operating member from the mounting seat and the plug connector.

### FIELD

The present disclosure relates to a mounting assembly for connecting a plug connector to a socket connector.

### BACKGROUND

Plug connectors are usually plugged to their matching socket connectors manually. Sometimes, the plug connectors are not easily to be aligned with their matching socket connectors, and cannot be plugged to their matching socket connectors easily.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a mounting assembly for connectors.

FIG. 2 is similar to FIG. 1, but viewed from another aspect.

FIG. 3 is a pre-assembled view of the mounting assembly of FIG. 1.

FIG. 4 is an assembled view of the mounting assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

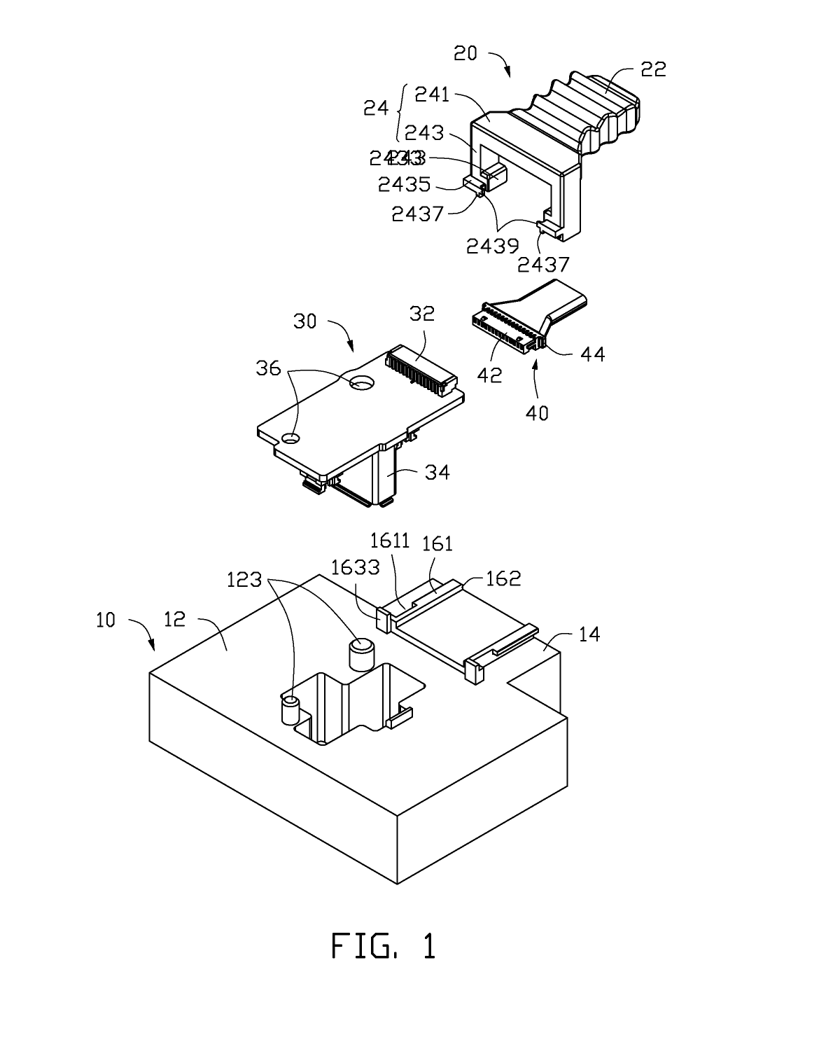

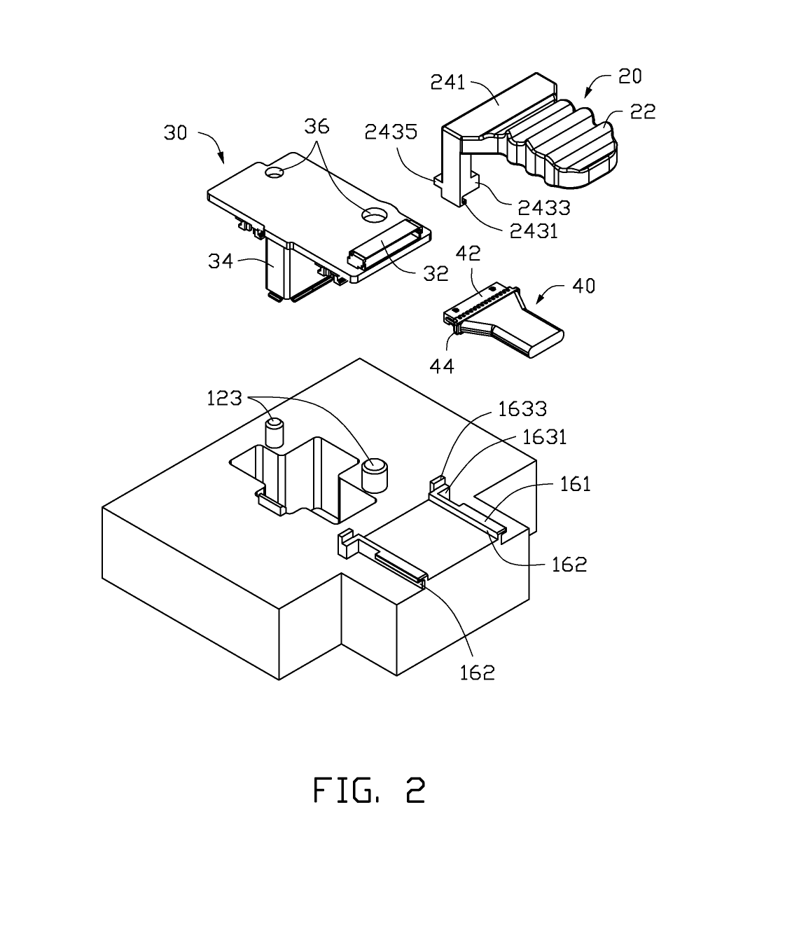

FIGS. 1 and 2 illustrate an embodiment of a mounting assembly. The mounting assembly includes a mounting seat 10, an operating member 20, a circuit board 30, and a plug connector 40. The mounting assembly is configured to the plug connector 40 to a socket connector 32 of the circuit board 30.

The mounting seat 10 includes a main portion 12 and a protruding portion 14 protruding from one side of the main portion 12 along a horizontal direction. A thickness of the main portion 12 is substantially the same as that of the protruding portion 14. A length of the protruding portion 14 is less than that of the main portion 12. A width of the protruding portion 14 is less than that of the main portion 12. An upper surface of the main portion 12 is on the same plane as the upper surface of the protruding portion 14. A groove 121 is defined in a center of the main portion 12. Two mounting posts 123 protrude upwardly from the main portion 12 and are located beside the groove 121. A resisting block 125 protrudes upwards from the main portion 12 and is located at an edge of the groove 121. A guiding portion 16 protrudes upwards from the protruding portion 14 and is aligned with the groove 121. A protruding height of the guiding portion 16 is substantially equal to the thickness of the circuit board 30. The guiding portion 16 includes a pair of side edges that is substantially perpendicular to a long edge of the protruding portion 14. A side wall 162 extends substantially perpendicularly from each of the pair of side edges of the guiding portion 16. A top flange 161 extends substantially perpendicularly from an upper edge of the side wall 162. The top flange 161 is substantially parallel to the upper surface of the protruding portion 14. A sliding slot 164 is defined between the top flange 161 and the upper surface of the protruding portion 14. A resisting flange 1631 extends substantially perpendicularly from an inner end of the side wall 162. A blocking piece 1633 is connected to the resisting flange 1631 and protrudes upwardly from a top of the resisting flange 1631. A gap 1611 is defined in the top flange 161 and communicates with the resisting flange 1631.

Two mounting holes 36 are defined in the circuit board 30 corresponding to the two mounting posts 123. The socket connector 32 is mounted on an upper side of the circuit board 30 and located adjacent to a short edge of the circuit board 30. An electronic member 34 is attached to a lower side of the circuit board 30.

The plug connector 40 includes a plugging portion 42 capable of being inserted into the socket connector 32 and a pair of protruding tabs 44 located at opposite sides of the plugging portion 42. The plugging portion 42 is located in front of the pair of protruding tabs 44.

The operating member 20 includes a handle 22 and a clamping portion 24 connected to a front side of the handle 22. The handle 22 can have a wave-shaped surface. The clamping portion 24 includes a connecting portion 241 and a pair of clamping arms 243 extending substantially perpendicularly and downwards from opposite ends of the connecting portion 241. Each of the pair of clamping arms 243 includes a sliding tab 2431, a first block 2433, a second block 2435, a first tab 2437, and a second tab 2439. The sliding tab 2431 extends downwardly from a bottom of each clamping arm 243 and has an L shaped (see FIG. 2). The sliding tab 2431 is slidable along the sliding slot 164. The first block 2433 protrudes from an inner surface of each clamping arm 243 along a first direction. The second block 2435 protrudes from a front surface of each clamping arm 243 along a second direction that is substantially perpendicular to the first direction. The first tab 2437 protrudes downwardly from the second block 2435 along a third direction that is substantially perpendicular to the first direction and the second direction. The second tab 2439 is located adjacent to the first tab 2437 and protrudes from the second block 2435 along the first direction. A gap 2440 is located between the second tab 2439 and the first block 2433 corresponding to the protruding tab 44 of the plug connector 40. The first block 2433, the second block 2435, the first tab 2437, and the second tab 2439 are located at a lower end of each clamping arm 243.

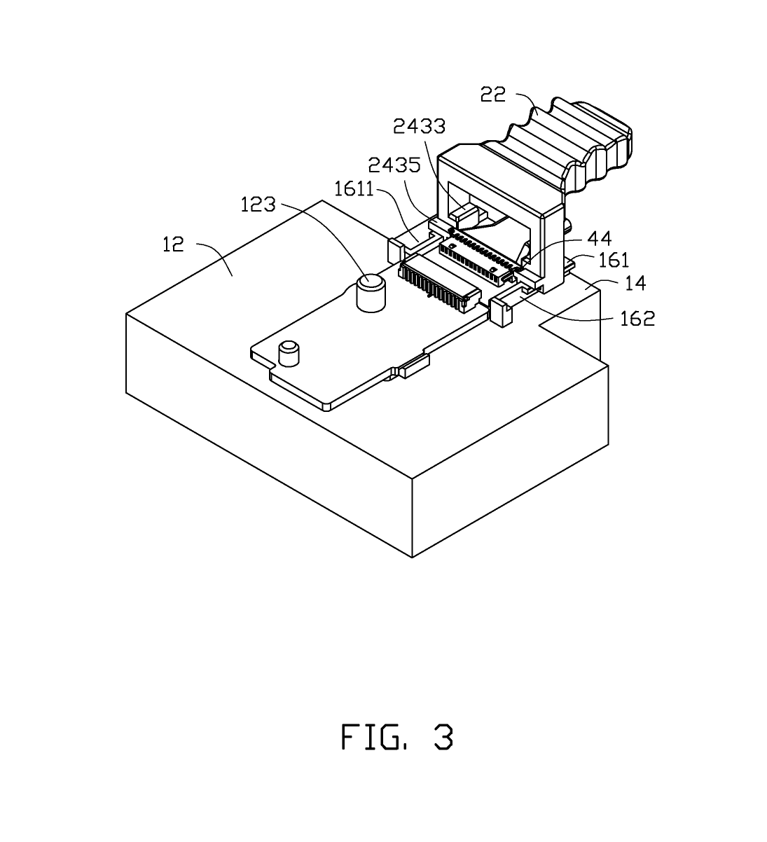

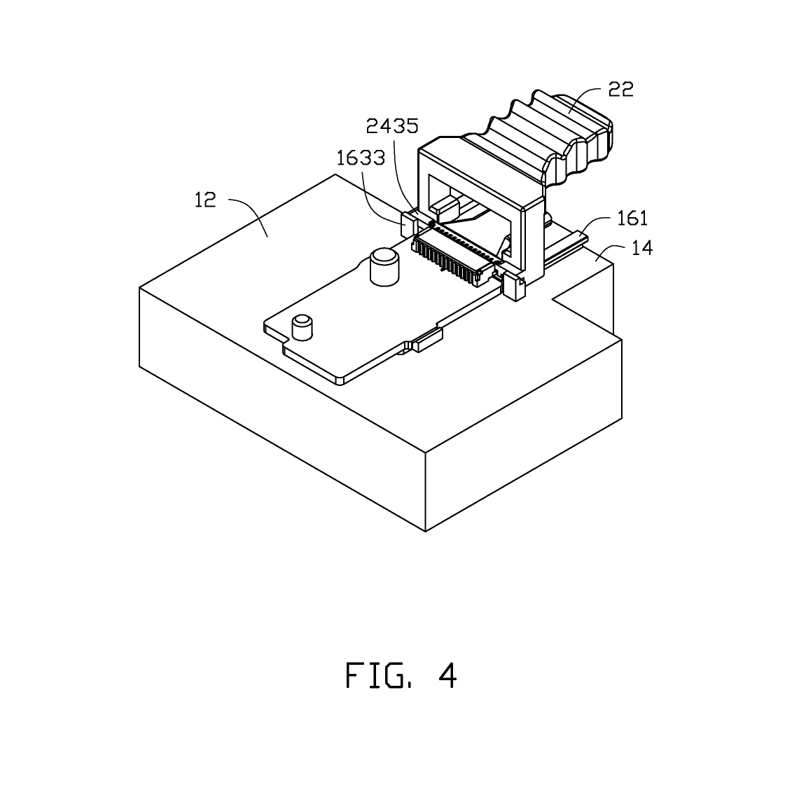

FIGS. 3 and 4 shows that in assembly the electronic member 34 extends through the groove 121. The two mounting posts 123 extend through the two mounting holes 36. The lower side of the circuit board 30 abuts the upper surface of the main portion 12. The resisting block 125 abuts against a side edge of the circuit board 30. The circuit board 30 is secured on the mounting seat 10. The sliding tab 2431 is slid into the sliding slot 164. The first tab 2437 abuts the side wall 162 and slides along the side wall 162. The sliding tab 2431 and the first tab 2437 are located at opposite sides of the side wall 162. The second block 2435 abuts the top flange 161 and slides along the top flange 161 (see FIG. 3). The plug connector 40 is placed between the pair of clamping arms 243. The protruding tab 44 is engaged with the gap between the first block 2433 and the second tab 2439. The operating member 20 and the plug connector 40 are moved towards the socket connector 32 until the plugging portion 42 is fully plugged into the socket connector 32. When the plugging portion 42 is fully plugged into the socket connector 32, the second block 2435 resists against the blocking piece. The sliding tab 2431 is located at the gap 1611. The operating member 20 is moved upwards to disengage from the mounting seat 10 and the plug connector 40.

It is to be understood that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A mounting assembly comprising:
a circuit board comprising a socket connector;
a plug connector capable of being plugged into the socket connector;
a mounting seat, configured for mounting the circuit board, and comprising a sliding slot and a gap located at an end of the sliding slot; and
an operating member, configured for pushing the plug connector to the socket connector, and comprising a pair of clamping arms for clamping the plug connector; each clamping arm comprising a sliding tab capable of sliding along the sliding slot;
wherein when the sliding tab is slid towards the gap along a first direction, the plug connector is capable of being plugged into the socket connector, and the sliding tab is capable of moving away from the gap along a second direction that is substantially perpendicular to the first direction for detaching the operating member from the mounting seat and the plug connector.

2. The mounting assembly of claim 1, wherein a guiding portion protrudes from an upper surface of the mounting seat and comprises a pair of side edges, a side wall extends substantially perpendicularly from each of the pair of side edges of the guiding portion, and a top flange extends substantially perpendicularly from an upper edges of the side wall, and the sliding slot is located below the top flange.

3. The mounting assembly of claim 2, wherein the sliding tab has an L shape and is located at a bottom of each of the pair of clamping arms.

4. The mounting assembly of claim 2, wherein the operating member further comprises a handle substantially perpendicular to the pair of clamping arms and a connecting member connected between the handle and the pair of clamping arms, and the pair of clamping arms extends substantially perpendicularly from opposite sides of the connecting portion.

5. The mounting assembly of claim 4, wherein the handle comprises at least one wave-shaped surface.

6. The mounting assembly of claim 4, wherein a first block protrudes from an inner side of each of the pair of clamping arms, a second block protrudes from a front side of each of the pair of clamping arms, and the plug connector comprises a protruding tab located between the first block and the second block.

7. The mounting assembly of claim 6, wherein the second block comprises a first tab and a second tab protruding from the second block, a protruding direction of the first tab is substantially perpendicular to that of the second tab, and the protruding tab is located in an interspace between the second tab and the first block.

8. The mounting assembly of claim 6, wherein the first tab and the sliding tab abuts against opposite sides of the side wall when the sliding tab is slid along the sliding slot.

9. The mounting assembly of claim 6, wherein a resisting flange extends substantially perpendicularly from an end of the side wall, the gap is communicated with the resisting flange; and a blocking piece is connected to the resisting flange and protrudes upwards from the resisting flange; and when the plug connector is fully plugged into the socket connector, the second block is resisted against the blocking piece for preventing the operating member and the plug connector moving along the first direction.

10. The mounting assembly of claim 2, wherein a protruding height of the guiding portion is substantially equal to a thickness of the circuit board, an upper surface of the circuit board lays in the same plane as the upper surface of the guiding portion.

11. A mounting assembly for attaching a first connector to a second connector comprising:
a mounting seat comprising a side wall, a top flange extending substantially perpendicularly from the side wall, a sliding slot located below the top flange, and a gap located at an end of the sliding slot; and
an operating member configured for pushing the first connector to the second connector when the operating member is moving along a first direction, and the operating member comprising a pair of clamping arms for clamping the first connector; each clamping arm comprising a sliding tab capable of sliding along the sliding slot;
wherein when the sliding tab is slid into the gap along the first direction, the sliding tab is capable of moving away from the gap along a second direction that is substantially perpendicular to the first direction for detaching the operating member from the mounting seat.

12. The mounting assembly of claim 1, wherein a guiding portion protrudes from an upper surface of the mounting seat and comprises a pair of side edges, the side wall extends substantially perpendicularly from each of the pair of side edges of the guiding portion.

13. The mounting assembly of claim 12, wherein the sliding tab has an L shape and is located at a bottom of each of the pair of clamping arms.

14. The mounting assembly of claim 11, wherein the operating member further comprises a handle substantially perpendicular to the pair of clamping arms and a connecting member connected between the handle and the pair of clamping arms, and the pair of clamping arms extends substantially perpendicularly from opposite sides of the connecting portion.

15. The mounting assembly of claim 14, wherein the handle comprises wave-shaped surfaces.

16. The mounting assembly of claim 14, wherein a first block protrudes from an inner side of each of the pair of clamping arms for pushing the first connector to the second connector when the operating member is moving along the first direction.

17. The mounting assembly of claim 16, wherein a second block protrudes from a front side of each of the pair of clamping arms and comprises a first tab and a second tab protruding from the second block, a protruding direction of the first tab is substantially perpendicular to that of the second tab, and a space is defined between the second tab and the first block.

18. The mounting assembly of claim 16, wherein the first tab and the sliding tab abuts against opposite sides of the side wall when the sliding tab is slid along the sliding slot.

19. The mounting assembly of claim 16, wherein a resisting flange extends substantially perpendicularly from an end of the side wall, the gap is communicated with the resisting flange; and a blocking piece is connected to the resisting flange and protrudes upwards from the resisting flange; and when the sliding tab is fully located in the gap, the second block is resisted against the blocking piece, thereby preventing the operating member moving along the first direction.

20. The mounting assembly of claim 19, wherein the first block and the second block are located above the top flange, and the sliding tab is located below the top flange.
